(19) United States
(12) Patent Application Publication
(10) Pub. No.: US 2007/0172584 A1
(43) Pub. Date: Jul. 26, 2007

(54) Method of manufacturing patterned magnetic recording medium

(75) Inventors: Naoko Kihara, Matsudo-shi (JP); Satoshi Shirotori, Fuchu-shi (JP); Yoshiyuki Kamata, Tokyo (JP); Masatoshi Sakurai, Tokyo (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/657,720

(22) Filed: Jan. 25, 2007

(30) Foreign Application Priority Data
Jan. 25, 2006 (JP) 2006-016109

(51) Int. Cl. B05D 5/12

(52) U.S. Cl. 427/127

(57) ABSTRACT

A method of manufacturing a patterned magnetic recording medium includes coating a magnetic film with a resist which is decomposed by exposure to electromagnetic radiation or an electron beam to have a low molecular weight, forming a pattern on the resist by an imprinting method, transferring the pattern to the magnetic film by using the resist having the pattern formed thereon as a mask, and removing the resist by exposing the resist to the electromagnetic radiation or the electron beam.

### CROSS-REFERENCE TO RELATED APPLICATIONS

This application is based upon and claims the benefit of priority from prior Japanese Patent Application No. 2006-016109, filed Jan. 25, 2006, the entire contents of which are incorporated herein by reference.

### BACKGROUND OF THE INVENTION

1. Field of the Invention

The present invention relates to a method of manufacturing a patterned magnetic recording medium.

2. Description of the Related Art

In recent years, a patterned magnetic recording medium in which a magnetic film is processed into a predetermined pattern to make it possible to expect a high recording density. In order to manufacture such a patterned magnetic recording medium, for example, the following method is used.

More specifically, a resist is coated on a magnetic film, and a mold on which a predetermined pattern is formed is imprinted on the resist to transfer the pattern. The magnetic film is processed by using the resist having the pattern formed thereon as a mask. Thereafter, an unnecessary resist is stripped.

A conventional resist is stripped by dry etching using a gas such as oxygen, SF₆, or CF₄ in general (for example, see JP-A 2005-56547 (KOKAI)). However, the magnetic characteristics of a magnetic film used as the recording layer may be varied due to influence of the gas used for resist removing. On the other hand, when the resist is stripped by, for example, a cleaning process with a solvent without using a dry process, reduction in production yield is concerned due to generation of defects caused by dust and the like.

### BRIEF SUMMARY OF THE INVENTION

According to an aspect of the present invention, there is provided a method of manufacturing a patterned magnetic recording medium comprising: coating a magnetic film with a resist which is decomposed by exposure to electromagnetic radiation or an electron beam to have a low molecular weight; forming a pattern on the resist by an imprinting method; transferring the pattern to the magnetic film by using the resist having the pattern formed thereon as a mask; and removing the resist by exposing the resist to the electromagnetic radiation or the electron beam.

### BRIEF DESCRIPTION OF THE SEVERAL VIEWS OF THE DRAWING

FIGS. 1A, 1B, 1C, 1D, 1E and 1F are cross-sectional views showing a method of manufacturing a patterned magnetic recording medium according to an embodiment;

FIG. 2 is a graph showing a magnetization curve of a magnetic film of a patterned magnetic recording medium according to Example 1;

FIG. 3 is a graph showing a magnetization curve of a magnetic film of a patterned magnetic recording medium according to Example 2;

FIG. 4 is a graph showing a magnetization curve of a magnetic film of a patterned magnetic recording medium according to Comparative Example 1; and

FIG. 5 is a graph showing a magnetization curve of a magnetic film of a patterned magnetic recording medium according to Comparative Example 2.

### DETAILED DESCRIPTION OF THE INVENTION

A resist material used in the present invention will be described below. The resist material used in the present invention is not particularly limited as long as the resist material has a property that it is decomposed by exposure to electromagnetic radiation or an electron beam to have a low molecular weight. The resist materials, which are decomposed by exposure to electromagnetic radiation or an electron beam to have a low molecular weight, include polymers decomposed by a reaction described in “Photoreactive Polymers” by Arnost Reiser, pp. 296-276, John Wiley & Son, Inc. (1989) and polymers described in J. Electrochem. Sco., 136, 245 (1989). The resist materials include, for example, polymers such as polyacrylate derivatives, polymethacrylate derivatives, poly(2-methylpentene-1-sulfone) derivatives, and polyphthalaldehyde derivatives, and copolymers containing these derivatives. More specifically, the resist materials include ZEP-520 (available from Zeon Corporation) which is a copolymer of a styrene derivative and an acrylate derivative, and poly(4-chlorophthalaldehyde).

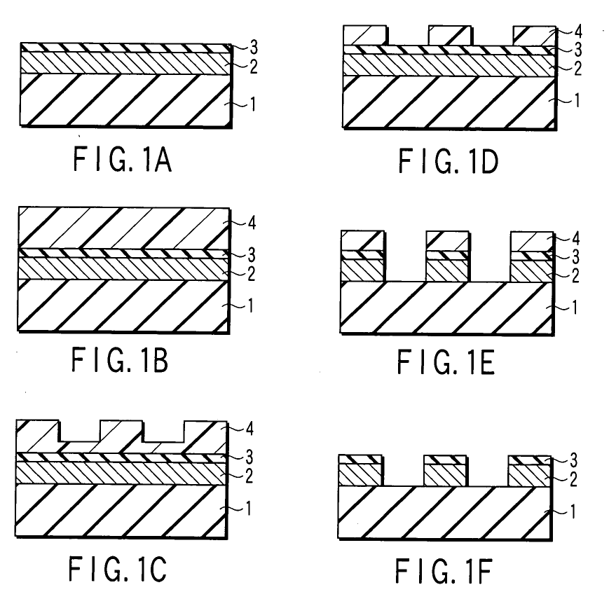

An example of a method of manufacturing a patterned magnetic recording medium according to an embodiment of the present invention will be described below with reference to FIGS. 1A, 1B, 1C, 1D, 1E and 1F.

As shown in FIG. 1A, a magnetic film 2 is formed on a substrate 1, and a carbon protective film 3 is formed on the magnetic film 2. Although a material of the substrate 1 is not particularly limited, a plastic substrate, glass substrate or silicon substrate is used in general. Surface treatment of the carbon protective film 3 is performed as needed.

As shown in FIG. 1B, the carbon protective film 3 is coated with a resist 4. At this time, a solution obtained by dissolving the resist in an appropriate solvent is applied by a method such as spin coating, dipping, spraying, or an ink-jet method. After the resist is applied, the solvent is removed at 80 to 150° C. as needed.

As shown in FIG. 1C, a mold (not shown) on which a predetermined pattern is formed is stacked to face the resist 4 and is pressed (imprinted) by means of a press. After the pressure is relieved, the substrate is removed from the mold thereby forming a pattern in the resist 4.

As shown in FIG. 1D, resist residues at the bottoms of recessed portions are removed by dry etching.

As shown in FIG. 1E, the carbon protective film 3 and the magnetic film 2 are etched by dry or wet etching by using the resist 4 having the pattern formed thereon as a mask to transfer the pattern to the magnetic film 2. At this time, as an etching gas, oxygen, CF₄, SF₆ or argon is used. However, the etching gas is not limited to these gases.

As shown in FIG. 1F, the remaining resist 4 is irradiated with electromagnetic radiation or an electron beam so that the molecular weight thereof is reduced, and then the substrate is heated under a reduced pressure thereby removing the resist 4. At this time, a heat treatment at high temperatures may cause alteration depending on the material of the magnetic film 3. For this reason, the heating temperature is preferably set to 20 to 250° C. The irradiation of the electromagnetic radiation or the electron beam may be performed before etching of the magnetic film if the irradiation does not adversely affect processing of the magnetic film.

### EXAMPLES

The present invention will be described in more detail on the basis of examples. However, the present invention is not limited to these examples.

### Example 1

A magnetic film and a carbon protective film were formed on a 2.5-inch substrate. A resist ZEP-520 (available from Zeon Corporation) was applied to the carbon protective film by spin-coating to have a thickness of 100 nm. ZEP-520 is a copolymer of a styrene derivative and an acrylate derivative. A nickel stamper having a pattern of 100 nm in width and 75 nm in depth was pressed on the resist by a press at a pressure of 1000 bar for 30 seconds thereby transferring the pattern to the resist. After resist residues at bottoms of recessed portions were removed by O₂-RIE (reactive ion etching), the carbon protective film and the magnetic film were processed by argon ion-milling by using the resist having the pattern formed thereon as a mask so as to form the predetermined pattern. The resist on the surface of the substrate was irradiated with ultraviolet light for 15 minutes with a UV cleaning apparatus, and then the substrate was heated at 200° C. for 40 minutes in a vacuum oven. The pattern was observed with an atomic force microscope (AFM) after the heat treatment. It was confirmed that the resist had been removed.

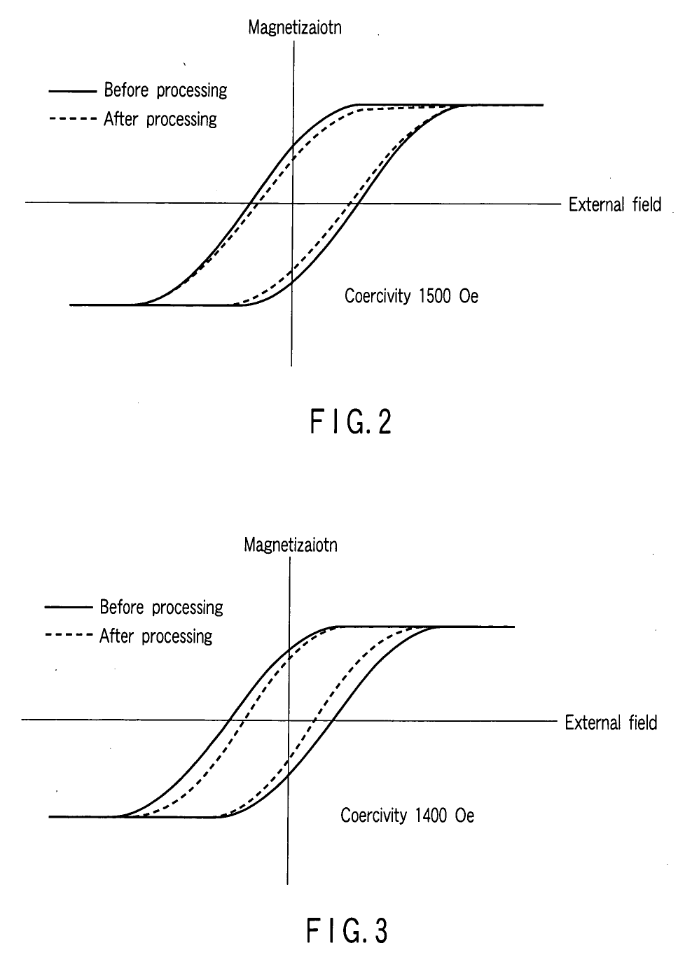

FIG. 2 shows the results obtained by measuring magnetization curves of the magnetic film before and after the processing with a vibrating sample magnetometer (VSM). Even after the processing, the magnetic film exhibited coercivity as high as approximately 1500 Oe that was obtained before the processing.

### Example 2

A cyclohexane solution of poly(4-chlorophthalaldehyde) as a resist was used and processing of the resist by imprinting and processing of the magnetic film were performed in the same manner as in Example 1. Thereafter, the resist on the surface of the substrate was irradiated with ultraviolet light for 5 minutes with a UV cleaning apparatus, and then the substrate was heated at 210° C. for 20 minutes in a vacuum oven. The pattern was observed with AFM after the heat treatment. It was confirmed that the resist had been removed.

FIG. 3 shows magnetization curves of the magnetic film before and after the processing. Even after the processing, the magnetic film exhibited magnetic characteristics almost similar to that before the processing.

### Comparative Example 1

As in Example 1, a magnetic film and a carbon protective film were formed on a 2.5-inch substrate, and then a solution prepared by diluting novolac-type resist S-1818 (available from Shipley Company) five times with PGMEA was applied to have a thickness of 100 nm. Processing of the resist by imprinting and processing of the magnetic film were performed in the same manner as in Example 1. Thereafter, the resist was stripped by oxygen plasma treatment.

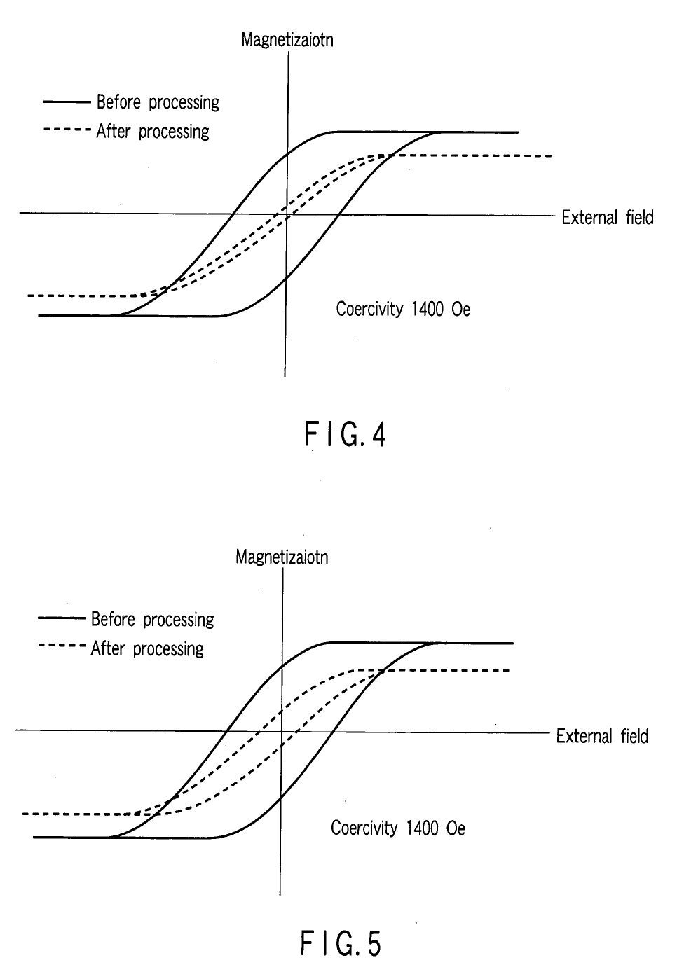

Magnetization curves of the magnetic film were measured with a VSM before and after the processing. As shown in FIG. 4, the magnetic film after the processing exhibited a magnetization curve different from that before the processing. It was understood that the magnetic film was modified.

### Comparative Example 2

OCD T-7 (available from Tokyo Ohka Kogyo Co., Ltd.), which is spin-on-glass, was used as a resist and processing of the resist by imprinting and processing of the magnetic film were performed in the same manner as in Example 1. Thereafter, the resist was stripped by dry etching using SF₆.

Magnetization curves of the magnetic film were measured with a VSM before and after the processing. As shown in FIG. 5, the magnetic film after the processing exhibited a magnetization curve different from that before the processing. It was understood that the magnetic film was modified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of manufacturing a patterned magnetic recording medium comprising:
coating a magnetic film with a resist which is decomposed by exposure to electromagnetic radiation or an electron beam to have a low molecular weight;
forming a pattern on the resist by an imprinting method;
transferring the pattern to the magnetic film by using the resist having the pattern formed thereon as a mask; and
removing the resist by exposing the resist to the electromagnetic radiation or the electron beam.

2. The method according to claim 1, wherein a protective film is formed on the magnetic film and the protective film is coated with the resist.

3. The method according to claim 1, wherein the pattern is transferred to the magnetic film by ion-milling the magnetic film.

4. The method according to claim 1, wherein the electromagnetic radiation is ultraviolet light.

5. The method according to claim 1, wherein the resist is heated to 20 to 250° C. in the removing step.

6. The method according to claim 5, wherein the resist is heated under a reduced pressure in the removing step.

7. The method according to claim 1, wherein the resist comprises a polyphthalaldehyde derivative or a copolymer of a styrene derivative and an acrylate derivative.

8. The method according to claim 1, wherein the polyphthalaldehyde derivative is poly(4-chlorophthalaldehyde).
